(19) United States
(12) Patent Application Publication
(10) Pub. No.: US 2026/0167542 A1
(43) Pub. Date: Jun. 18, 2026

(54) METHOD AND SYSTEM FOR CONTROLLING SCALE DEPOSITION IN A GEOTHERMAL SYSTEM

(71) Applicant: CHEMTREAT, INC., Glen Allen, VA (US)

(72) Inventors: Kevin A. WHITE, Richmond, VA (US); Santanu BANERJEE, Glen Allen, VA (US); William HENDERSON, Midlothian, VA (US)

(73) Assignee: CHEMTREAT, INC., Glen Allen, VA (US)

(21) Appl. No.: 19/407,507

(22) Filed: Dec. 3, 2025

Related U.S. Application Data
(60) Provisional application No. 63/735,534, filed on Dec. 18, 2024.

(51) Int. Cl. C02F 5/12; C08G 69/10

(52) U.S. Cl. CPC C02F 5/12; C08G 69/10

(57) ABSTRACT

A method for inhibiting scale deposition in a geothermal system, the method includes treating a water stream of the geothermal system with a scale inhibitor composition, wherein the scale inhibitor composition comprises a compound that includes a peptide bond. The compound that includes the peptide bond may be polypeptide, such as polyaspartic acid. The scale inhibitor composition may include a ligand or dispersant polymer.

### BACKGROUND

In a geothermal system, for example, such as a geothermal energy system or a geothermal lithium extraction system, geothermal brine is produced at high temperatures and higher than ambient pressure. This causes mineral deposits and scale to form in the geothermal system, such as deposits of barium sulfate and calcium fluoride.

Scale in geothermal systems is a serious problem. It causes undesirable consequences, including loss of heat transfer, increased cleaning frequency, equipment repairs and replacements, shutdowns, environmental problems, and increasing resources and costs associated with each.

In addition, scale in geothermal systems can include naturally occurring radioactive materials (NORMs) such as radium, uranium, and thorium. For example, the barium sulfate and calcium fluoride accumulate as scale in the geothermal system and carry naturally occurring NORMs along with them. The NORMs may also accumulate and form a radioactive contamination hazard or radioactive waste if the scale deposits are untreated. The radioactive contamination hazard or radioactive waste may be dangerous to workers and the surrounding environment. This may, in turn, lead to increased costs.

Accordingly, there is a need for a system and method that can reduce and inhibit scale and the amount of NORMs in a geothermal system.

### SUMMARY

Aspects of the present disclosure provide a method for inhibiting scale deposition in a geothermal system, the method comprising: treating a water stream of the geothermal system with a scale inhibitor composition, wherein the scale inhibitor composition comprises a compound that includes a peptide bond.

According to some embodiments, it is possible to reduce and inhibit scale in a geothermal system. This, in turn, reduces the accumulation of NORMs in the system, preventing the formation of a radioactive contamination hazard or radioactive waste.

### BRIEF DESCRIPTION OF THE DRAWINGS

FIG. 1 is a schematic view of an embodiment of a geothermal system;

FIG. 2 is a graph of scale inhibition achieved by different scale inhibitor compositions at various dosages;

FIG. 3 is a graph of scale inhibition achieved by different inventive scale inhibitor compositions at various dosages;

FIG. 4 is an image of the untreated water in comparison to water treated with a scale inhibitor composition;

FIG. 5 is an image of the untreated water in comparison to water treated with a scale inhibitor composition;

FIG. 6 is an image of the untreated water in comparison to water treated with a scale inhibitor composition;

FIG. 7 is an image of the untreated water in comparison to water treated with a scale inhibitor composition;

FIG. 8 is an image of the untreated water in comparison to water treated with a scale inhibitor composition;

FIG. 9 is an image of the untreated water in comparison to water treated with an inventive scale inhibitor composition;

FIG. 10 is an image of water treated with a scale inhibitor composition in comparison to water treated with an inventive scale inhibitor composition;

FIG. 11 is a graph of scale inhibition achieved by different scale inhibitor compositions in combination with different chelants; and

FIG. 12 is a graph of scale inhibition achieved by different scale inhibitor compositions in combination with citric acid at various dosages.

### DETAILED DESCRIPTION OF EMBODIMENTS

In the following description, numerous details are set forth to provide an understanding of the present disclosure. However, it may be understood by those skilled in the art that the methods and systems of the present disclosure may be practiced without these details and that numerous variations or modifications from the described embodiments may be possible.

Disclosed embodiments will now be described with respect to exemplary embodiments of geothermal systems. It will be understood that it is not intended for this disclosure to be limited to these specific embodiments.

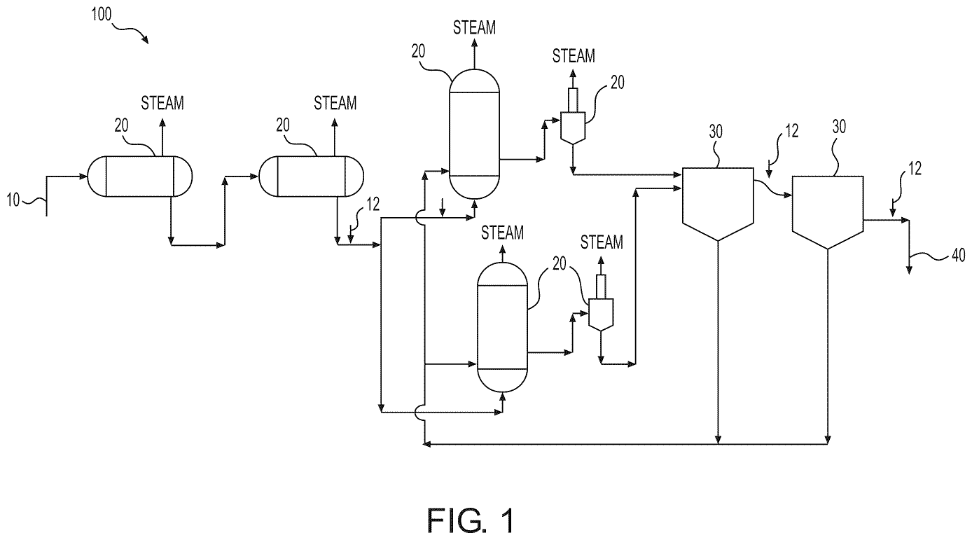

As used herein, geothermal system is not particularly limited and may include, for example, a geothermal well, a geothermal energy system, a geothermal lithium extraction system, or any system including or extracting geothermal brine. For example, as discussed below, the embodiment depicted in FIG. 1 includes a boiler 20 and a clarifier 30. However, the geothermal system is not limited to such and does not need to include the components described herein.

As used herein, water, water stream, and water supply, for example as used in a water system or a geothermal system, are not particularly limited and may include, for example, any aqueous solution, such as geothermal brine, comprising at least 50%, 75%, 90%, 95% or 99% water.

In embodiments, scale inhibitor composition may be added to a geothermal system to reduce and/or inhibit scale accumulation in the geothermal system. As discussed above, the scale inhibitor compositions may, thereby, reduce or inhibit the formation of radioactive contamination in the geothermal system. Disclosed herein are scale inhibitor compositions, methods, and systems for treating geothermal systems which may include NORMs.

### Geothermal System

FIG. 1 depicts an embodiment of a geothermal system 100. The geothermal system 100 can employ aqueous working fluids to extract geothermal energy from a subterranean system. A working fluid, such as a water stream, can be injected into a geothermal subterranean system through an injection inlet and allowed to heat within the subterranean system. In certain embodiments, the water stream may pass through one or more wellbores and/or fractures (e.g., primary and/or secondary) in a subterranean formation. A subterranean system is a high-temperature, underground system useable for geothermal energy production. For example, the water stream can be injected through an injection conduit to a subterranean production well, where the water stream is heated. The water stream can absorb heat from the subterranean rock formations. For example, the water stream can be heated to a temperature in a range of about 125° C. to about 400° C., about 150° C. to about 350° C., or about 200° C. to about 325° C. The heated water stream is then produced through a production outlet. The produced water stream can include hot water and/or geothermal brine that is pumped to the surface. The pressure may drop as the water rises to the surface, causing it to vaporize into steam. After production, the water vapor or steam can be used to drive one or more turbines for geothermal energy production, e.g., to generate electric power.

In FIG. 1, geothermal brine 10, such as hot water and/or steam, that is pumped from a production well may be fed into at least one boiler 20. The at least one boiler 20 may produce steam from the geothermal brine 10. The boilers 20 may operate at varying temperatures and pressures. The amount of boilers 20 is not particularly limited and any number of boilers 20 may be used. In addition, the geothermal system 100 is not limited to the at least one boiler 20, and the method and/or device for producing steam from the geothermal brine is not particularly limited. For example, the geothermal system 100 may alternatively, or in addition to the at least one boiler 20, include an evaporator, vaporizer, a flash drum, a distillation column, or any component capable of producing steam from water, such as the geothermal brine 10. The steam generated may be utilized to produce electricity.

A process stream may then be fed into at least one clarifier 30. The at least one clarifier 30 may separate out solids and precipitation from the process stream. The amount of clarifiers 30 is not particularly limited and any number of clarifiers 30 may be used. In addition, the geothermal system 100 is not limited to the at least one clarifier 30, and the method and/or device for removing a precipitate or solid from the geothermal system 100 is not particularly limited. For example, the geothermal system 100 may alternatively or in addition to the at least one clarifier 30 include a filter, a centrifuge, a settling tank, or any component capable of separating a precipitate or solid from the geothermal system 100.

After passing through the at least one clarifier 30, heat-depleted geothermal brine 40 may then be pumped back into the ground, for example, through an injection conduit and/or an injection well.

The geothermal system 100 is not particularly limited, and the depicted geothermal system is only provided as an example. In some embodiments, the geothermal system may include components for metal extraction including lithium extraction, heat exchangers, condensers, cooling towers, turbines, and generators amongst other components which may be known in the art.

The geothermal system 100 may operate at temperatures in the range of 1 to 500° C.; 20 to 300° C.; and 100 to 235° C. and at pressures in the range of 5 to 700 psi; 10 to 500 psi; and 100 to 400 psi.

The scale inhibitor composition may be added to the geothermal system 100 at an injection site 12. The scale inhibitor composition may be added at any point in the geothermal system 100 and is not limited to, for example, the injection sites 12. As shown in FIG. 1, the injection sites 12 are positioned between boilers 20, between clarifiers 30, and after a final clarifier 30 before entering the injection well. In some embodiments, the geothermal system may include only one injection site 12.

### Scale Inhibitor Composition

The scale inhibitor composition comprises a compound that includes a peptide bond. The compound that includes the peptide bond may be represented by Formula (I):

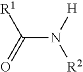

where R¹ and R² are independently a hydrocarbon group optionally substituted by a heteroatom.

The compound that includes the peptide bond may be a polymer, such as a polypeptide. In some embodiments, the compound that includes the peptide bond may be, but is not limited to, polyaspartic acid, for example, which may be depicted as in Formula (II):

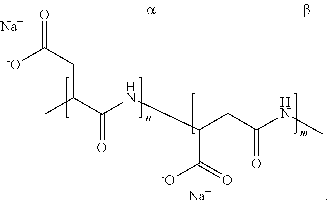

The peptide bond includes nitrogen in a polymer backbone and oxygen in the molecule, each of the nitrogen and the oxygen having lone pair electrons. Without being bound by theory, it is believed that these lone pair electrons may help aid in adsorption of the compound including the peptide bond onto the scale forming compounds, such as barium sulfate and calcium fluoride. This enables the polymer to inhibit formation of the scale forming compounds while simultaneously causing the scale forming compounds to break apart. In addition, the peptide bond includes an amino group which may work in combination with a carboxylic group to further inhibit and/or remove scale.

In some embodiments, the scale inhibitor composition may chelate scale forming metal ions preventing precipitation, i.e., keeping the scale forming metal ions in the geothermal brine 10. The scale inhibitor composition may also penetrate scale already formed in a system and break up the scale, causing it to release from, for example, a pipe or conduit in the system, and possibly even dissolve back into the geothermal brine 10.

The compound that includes the peptide bond may have a molecular weight in the range of 10 to 30,000 daltons, 50 to 20,000 daltons, 500 to 15,000 daltons, or 1,000 to 10,000 daltons.

The scale inhibitor composition may be thermally stable under operational conditions of a geothermal system. For example, the scale inhibitor composition may be thermally stable in the range of 1 to 500° C.; 20 to 300° C.; and 100 to 235° C. and at pressures in the range of 5 to 700 psi; 15 to 600 psi; and 100 to 500 psi.

A dosage treatment of the scale inhibitor composition may be added to the geothermal system 100 in a dosage in the range of 0.0001 to 500 ppm; 0.001 to 100 ppm; 0.01 to 50 ppm; 0.05 to 15 ppm; and 0.075 to 0.5 ppm.

The scale inhibitor composition may provide at least 10%; at least 20%, at least 40%; at least 60%; at least 80%; at least 90%; at least 95%; or at least 99% scale inhibition in the geothermal system.

A percentage of scale inhibition may be determined by comparing an amount of scale produced in a treated system versus that of an untreated system. For example, the percentage of scale inhibition may be determined by ((the amount of scale formed in an untreated system)-(the amount of scale formed in a treated system))/(the amount of scale formed in an untreated system) multiplied by 100.

The scale inhibitor composition may further comprise a ligand or a chelate. The ligand or chelate may be but is not limited to, for example, at least one selected from the group consisting of citric acid, EDTA (ethylenediaminetetraacetic acid), GLDA (glutamic acid diacetate), MGDA (methylglycinediacetic acid), DETPMP (diethylenetriamine penta (methylene phosphonic acid)), HEDP (hydroxyethylidene diphosphonic acid), organic acids, aminomethylenecarboxlates, aminomethylenecarboxylic acids (NTA, DTPA, etc.), aminomethylenephosphonic acid (NTP, HDTP, etc.), glucoheptanoate, and EDDS and EDG (CAS 135-37-5), including salts of the above described acids.

The ligand or chelate may be added to the geothermal system in a dosage in the range of 1 to 1,000 ppm, 5 to 500 ppm, 35 to 300, and 50 to 200 ppm.

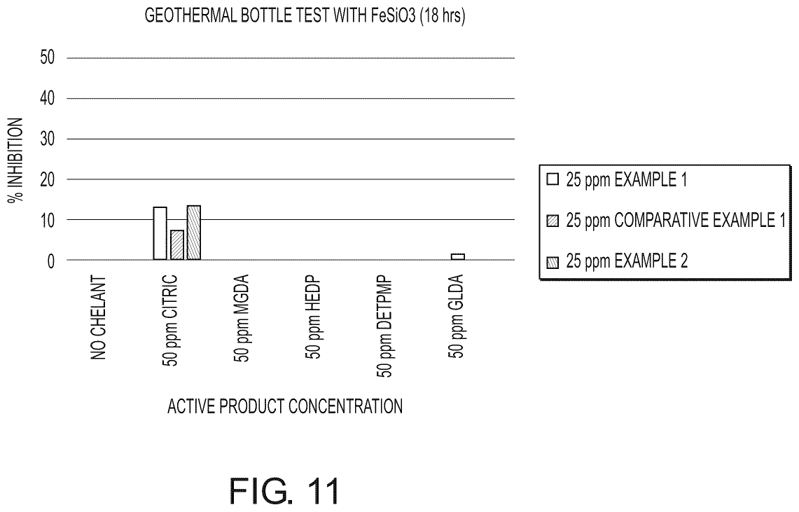

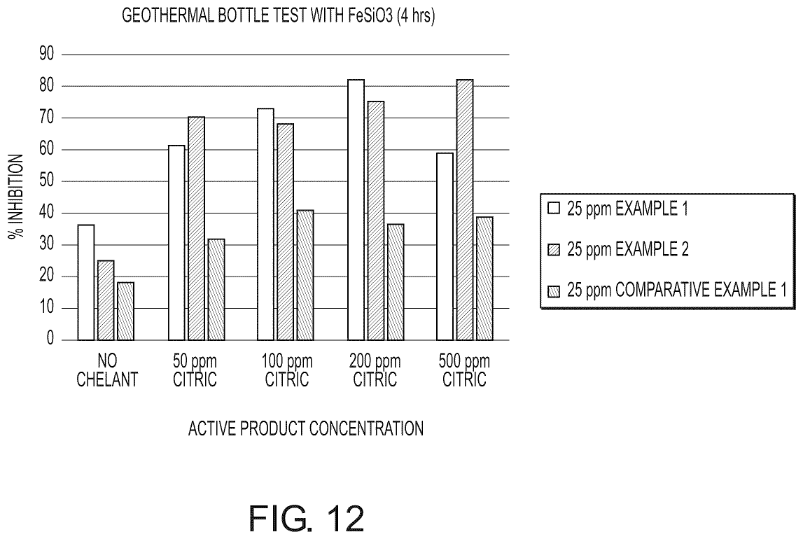

A ligand or chelate may increase the efficiency of the scale inhibitor composition, for example, increasing the ability of the scale inhibitor composition to inhibit and reduce scale in the geothermal system. When the geothermal brine being treated with the scale inhibitor composition includes a high concentration of iron, such as Fe, SiO₂, or FeSiO₃, a ligand or chelate may further increase the efficiency of the scale inhibitor composition, as shown in FIGS. 11 and 12 and discussed in more detail below.

The scale inhibitor composition may further comprise a dispersant polymer. The dispersant polymer may include but is not limited to polyacrylic acid, solvent, aqueous polymaleic acid, acrylic: AMPs copolymers, and maleic: acrylic copolymers, where AMPS copolymers are a copolymer of 2-acrylamido-2methyl propane sulfonate and acrylamide.

The dispersant polymer may be added to the geothermal system in a dosage in the range of 1 to 1,000 ppm, 5 to 500 ppm, 35 to 300, and 50 to 200 ppm.

A dispersant polymer may increase the efficiency of the scale inhibitor composition, for example, increasing the ability of the scale inhibitor composition to inhibit and reduce scale in the geothermal system. When the geothermal brine being treated with the scale inhibitor composition includes a high concentration of iron, such as Fe, SiO₂, or FeSiO₃, a dispersant polymer may further increase the efficiency of the scale inhibitor composition.

The geothermal brine may include iron. The iron may be in the form of Fe, FeSiO₂, or FeSiO₃. A content of iron in the geothermal brine may be in the range of 0 to 8,000 ppm; 200 to 6,000 ppm; 500 to 4,800 ppm; 700 to 3,800 ppm; 1,000 to 2,500 ppm; or 1,200 to 2,200 ppm. Iron in the geothermal brine may prevent or reduce the effectiveness of scale inhibitors from reducing and/or inhibiting the formation of scale. In addition, iron in the system may contribute to additional scale forming in the system. For example, traditional scale inhibitors lack effectiveness at concentrations of iron in the geothermal brine of 200 ppm or greater, as discussed in more detail below with respect to FIGS. 11 and 12. However, combining the compound with a peptide bond with a ligand, chelate, and/or dispersant polymer can increase the effectiveness of the inhibiting or reducing the formation of scale even in the presence of high concentrations of iron, such as within the above ranges.

The scale inhibitor composition may also inhibit or reduce the amount of NORMs in a geothermal system. For example, the scale inhibitor composition may reduce the amount of radiation measured in the system or a part of the system, such as a pipe or a conduit, to less than 5,000 Bq/kg; less than 3,000 Bq/kg; less than 2,000 Bq/kg; less than 1,000 Bq/kg; less than 500 Bq/kg; less than 250 Bq/kg; less than 100 Bq/kg; less than 50 Bq/kg; less than 30 Bq/kg, or less than 15 Bq/kg.

In some embodiments, a chemical treatment, such as a precipitant, may be applied to or injected into the geothermal system to precipitate a compound, for example, including the scale forming compounds. The precipitate may then be removed from the water. In some embodiments, the precipitate may be removed by the clarifier 30. The precipitate may include an accumulation of NORMs, facilitating removal of NORMs from the system by way of precipitation. For example, the scale forming compounds or another precipitate may carry the NORMs. Thus, by precipitating and removing the scale forming compounds or another precipitate, NORMs may be removed from the geothermal system 100. Additionally, NORMs may pass through the geothermal system 100 without accumulating to a dangerous or otherwise high level of radiation, for example because the accumulation of scale is prevented in the geothermal system 100 by the scale inhibitor composition, thereby preventing accumulation of NORMs. In this case, the NORMs may be expelled from the geothermal system 100, for example, after traversing through the geothermal system 100 and be pumped back into the ground, for example, through an injection conduit and/or an injection well or even released into the atmosphere through steam, for example, by a boiler 20.

The foregoing is further illustrated by reference to the following examples, which are presented for purposes of illustration and are not intended to limit the scope of the present disclosure.

### Examples

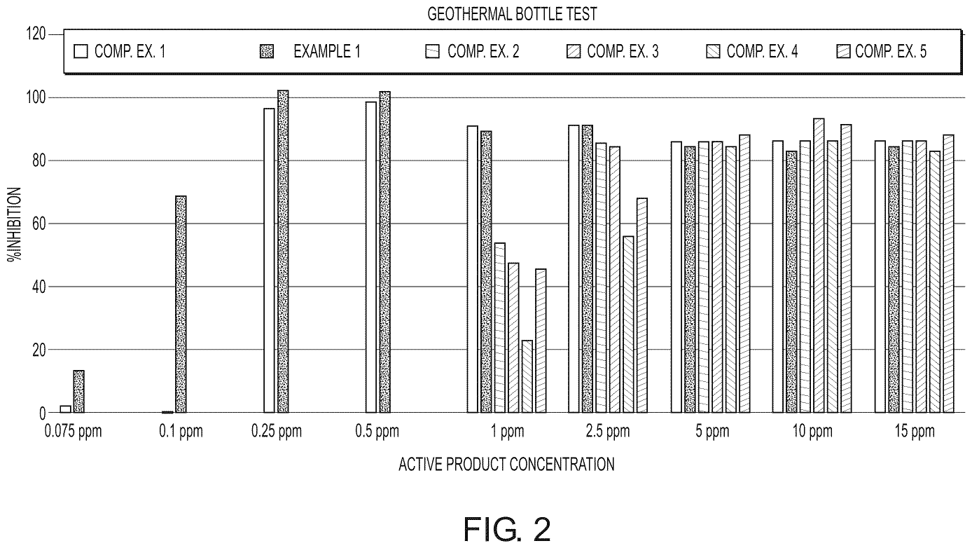

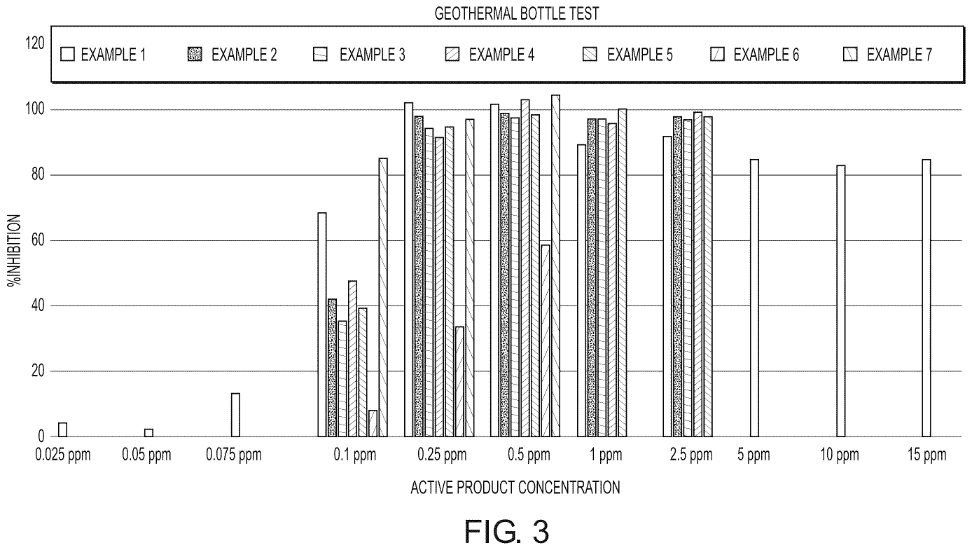

Samples were prepared and tested as described below. A sample of synthetic geothermal water was prepared in accordance with Table 1. The scale inhibitors of Table 2 were added to the synthetic water at various dosages, as shown in FIGS. 2 and 3. The samples were then mixed in a shaking water bath at 90° C. for 18 hours and maintained at 120 rpm. The results are shown in FIGS. 2 and 3.

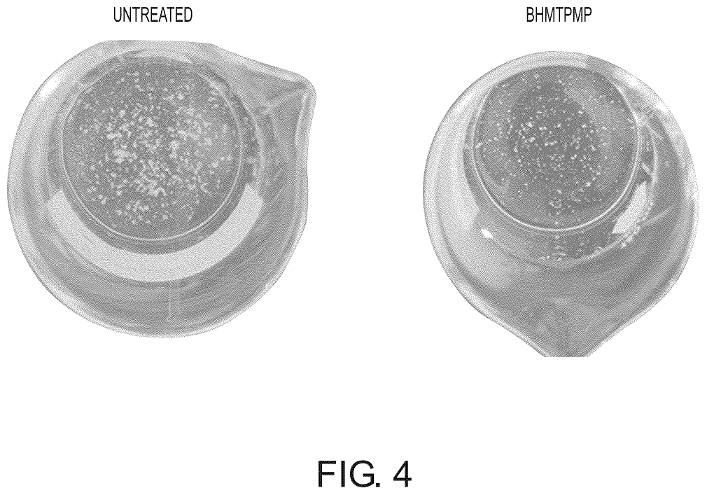

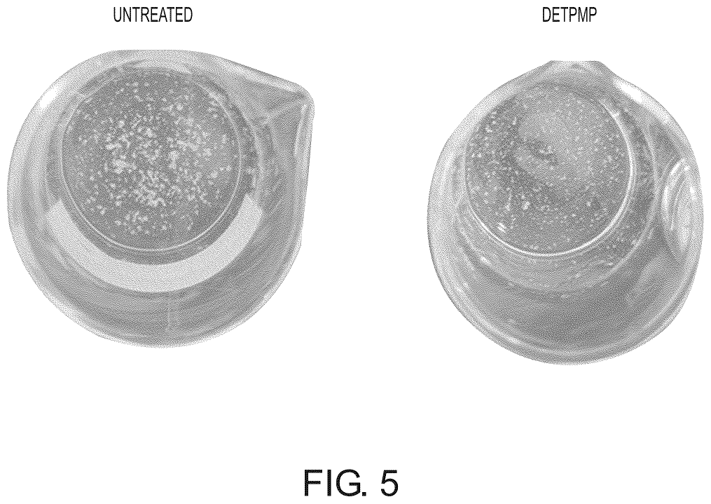

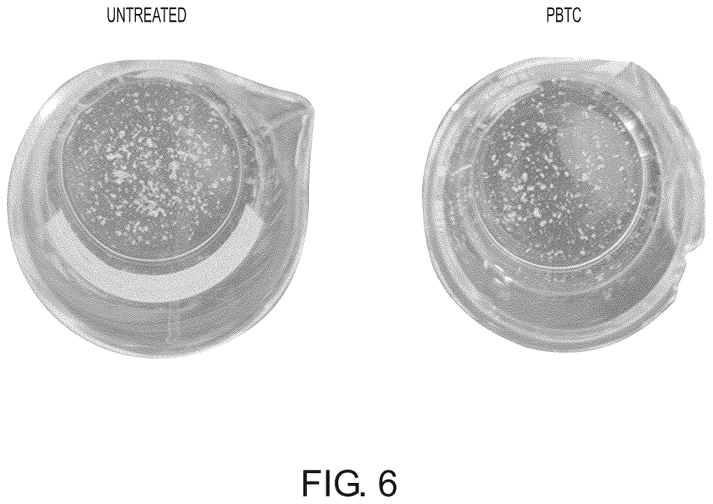

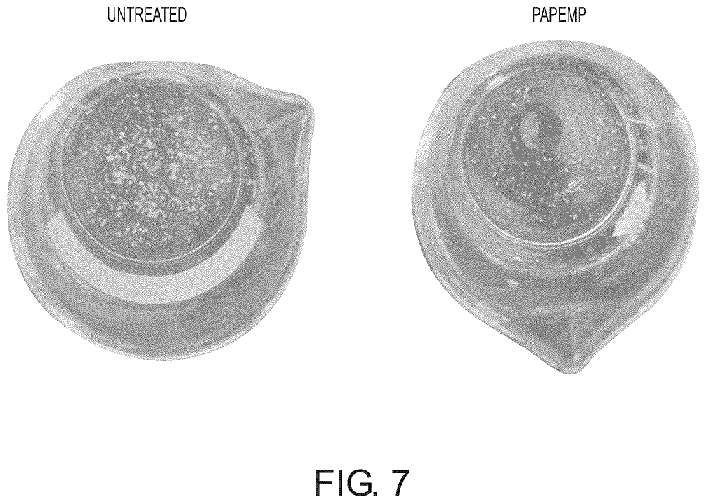

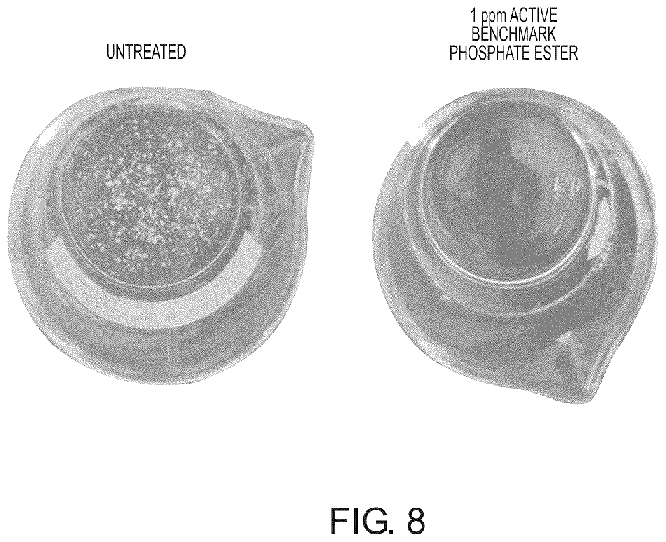

The scale inhibition was determined by measuring the amount of barium sulfate accumulated as scale in the sample after removal from the shaking water bath. Although calcium fluoride and other scales were not measured, it is theorized that other scale forming compounds, such as calcium fluoride, were inhibited in a comparable or proportional amount to that of barium sulfate. This is evidenced by at least FIGS. 3-10, which provide visual depictions of all scale formed in the samples. In addition, the amount of NORMs in a sample or a system is strongly correlated with the amount of barium sulfate. Accordingly, the amount of barium sulfate inhibited or removed from a sample is equivalent to or proportional to the amount of NORMs inhibited or removed.

TABLE 1
Synthetic Geothermal Water Make-up

| Target Species | mg/L |
|---|---|
| Ba | 220 |
| Sr | 856 |
| Ca as CaCO₃ | 76417 |
| as Ca | 30600 |
| Mg as CaCO₃ | 132 |
| as Mg | 32 |
| M-Alk as CaCO₃ | 0 |
| Fe | 0 |
| SO₄ | 200 |
| K | 19000 |
| Na | 50428 |
| Cl | 149840 |
| F | 25 |
| Mn | 1475 |
| Zn | 735 |
| B | 405 |
| SiO₂ | 0 |
| pH | 5.50 |
| Temp (° C.) | 90 |

TABLE 2
Scale Inhibitors

| Example | Scale Inhibitor Active Ingredient |
|---|---|
| Examples 1-7 | Polyaspartic Acid |
| Comparative Example 1 | TEA Phosphate Ester |
| Comparative Example 2 | DETPMP |
| Comparative Example 3 | BHMTPMP |
| Comparative Example 4 | PBTC |
| Comparative Example 5 | PAPEMP |

As shown in Table 2, Examples 1-7 included polyaspartic acid as a compound that includes a peptide bond, and Comparative Examples 1-5 included traditional scale inhibitors without a peptide bond. Traditional scale inhibitor compositions in a geothermal system typically include phosphonates, amino phosphonates, and phosphate ester compounds e.g., TEA phosphate ester (triethanolamine phosphate ester), PAPEMP (polyamino polyether methylene phosphonic acid), DETPMP, BHMTPMP (bis(hexamethylene triamine penta (methylene phosphonic acid)), PSO (phosphinosuccinic oligomer), and PBTC (phosphonobutane tricarboxylic acid).

As shown in FIG. 2, Example 1 was added to the synthetic geothermal water at various dosages ranging from 0.075 to 15 ppm. Comparative Example 1, a TEA phosphate ester produced by Novastar™ (product NS-8008), was also tested at dosages ranging from 0.075 to 15 ppm. Other traditional scale inhibitor compositions, such as Comparative Examples 2-5, were tested at dosages ranging from 1 to 15 ppm. After testing Comparative Examples 2-5 at dosages of 1 to 15 ppm, it was determined that these traditional scale inhibitors do not provide a comparative percentage of inhibition at lower concentrations, and thus, they were not tested at dosages below 1 ppm. For example, Comparative Example 4 provided roughly 22% inhibition at 1 ppm, roughly 55% inhibition at 2.5 ppm, and roughly 80-85% inhibition at 5 ppm, 10 ppm, and 15 ppm. Thus, Comparative Example 4 was determined to achieve inferior scale inhibition at concentrations below 5 ppm. Comparative Examples 2-3 and 5 behaved similarly.

Example 1 achieved superior percentages of inhibition across a broad spectrum of dosage concentrations in comparison to the traditional scale inhibitors in the Comparative Examples. In addition, Example 1 achieved far superior results at dosages of 2.5 ppm and below, even more superior results at dosages of 1 ppm and below, and most superior results at dosages of 0.1 ppm and below. In comparison, only Comparative Example 1 achieved comparative percentages of inhibition at dosage below 5 ppm. However, Comparative Example 1 achieved inferior percentages of inhibition at both 0.1 ppm and 0.075 ppm. In fact, Comparative Example 1 achieved negative percentages of scale inhibition at 0.1 ppm. Thus, at this concentration, Comparative Example 1 resulted in additional scale forming in the system. In comparison, Example 1 achieved almost 70% scale inhibition.

Accordingly, FIG. 2 demonstrates that the traditional scale inhibitors lack effectiveness when applied to a geothermal system at a dosage of 5 ppm or less, 2.5 ppm or less, 1 ppm or less, 0.25 ppm or less, and even more so at 0.1 ppm or less, in comparison to the inventive Example 1.

Without being bound by theory, it is speculated that the phosphate ester of Comparative Example 1 is not a polymer and lacks any nitrogen lone pair electrons that would aid in adsorption. The other traditional scale inhibitors face similar disadvantages. Therefore, the inventive scale inhibitor composition which includes a peptide bond can provide superior inhibition and reduction of scale forming compounds in comparison to the phosphate ester and other known scale inhibitors.

In FIG. 3, Examples 1-7 were tested and evaluated in a similar manner as described above with respect to FIG. 2. Examples 1-7 varied only with respect to their molecular weight. Example 1 was tested at dosages of 0.025 to 15 ppm. Examples 2-5 were only tested at dosages of 0.1 to 2.5 ppm. Examples 6-7 were only tested at dosages of 0.1 to 0.5 ppm.

As shown in FIG. 3, Example 1 achieved scale inhibition across a dosage range of 0.025 to 15 ppm. FIG. 3 also demonstrates that Example 1 can achieve some scale inhibition at dosage below 0.075 ppm. Examples 1-7 each demonstrated superior scale inhibition to the Comparative Examples at dosage concentrations of at least 0.1 ppm. It is speculated that each inventive Example would continue in this trend and achieve superior inhibition at concentrations below 0.1 ppm as well. Although Examples 1-7 only tested polyaspartic acid, it is speculated that any compound with a peptide bond would behave similarly and provide comparable scale inhibition because, as discussed above, of the lone pair electrons in the peptide bond.

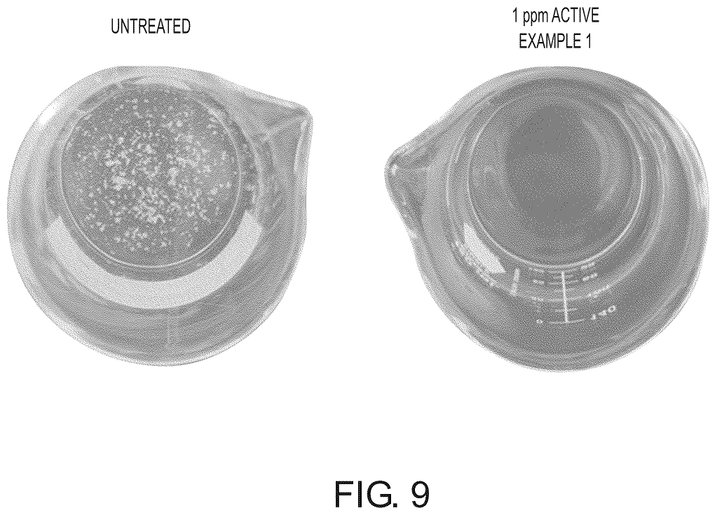

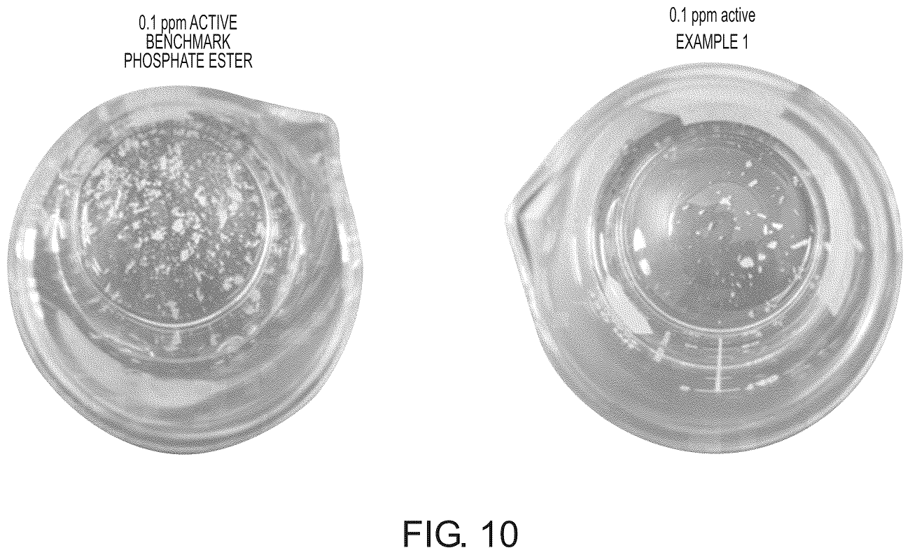

FIGS. 3-10 depict comparisons of untreated samples of the synthetic geothermal water to samples treated with the Comparative Examples and Example 1, at varying dosage. As shown in FIGS. 3-10 and as discussed above, scale formed in the samples may be visually compared to the untreated sample of synthetic geothermal water. It can, thus, be visually determined that Example 1, as shown in FIGS. 9 and 10, provides the least amount of scale formation of the tested samples.

In FIG. 11, Examples 1 and 2 and Comparative Example 1 were prepared as described above with respect to FIG. 2 except for the following changes: chelants were added to the samples, as shown in FIG. 11, and the synthetic geothermal water-make-up was the same as Table 1 except for the addition of iron and silicate in amounts of 2200 ppm Fe and 255 SiO₂. The samples were tested and evaluated as described above with respect to FIG. 2, except the temperature of the shaking water bath was increased to 105° C.

Under these harsher conditions, each sample tested achieved 0% scale inhibition when no chelant was added. The scale inhibition measured in the absence of a chelant demonstrates how iron and silicate reduces scale inhibitor efficiency. Citric acid was found to be particularly effective at a high concentration of Fe when in combination with a scale inhibitor, and Examples 1 and 2 provided superior scale inhibition over Comparative Example 1 when provided in combination with citric acid. Example 1 also provided some scale inhibition in combination with GLDA.

In FIG. 12, Examples 1 and 2 and Comparative Example 1 were prepared as described above with respect to FIG. 11 except that varying concentrations of citric acid were added to the samples, as shown in FIG. 12. The samples were tested and evaluated as described above with respect to FIG. 11, except that the time spent in the shaking water bath was decreased to 4 hours.

The scale inhibition measured without a chelant was higher than demonstrated in FIG. 11. This is due to the shorter amount of time in the shaking water bath. FIG. 12 demonstrates that chelants, such as citric acid, provide superior results in combination with the inventive scale inhibitor composition, for example, in comparison to that of Comparative Example 1. As shown in FIG. 12, the scale inhibition of Examples 1 and 2 increased by larger percentages when citric acid was added in comparison to Comparative Example 1. Moreover, at citric acid dosages of 200 ppm and 500 ppm, the scale inhibition achieved by Example 1 and Example 2, respectively, were over double of that achieved by Comparative Example 1.

It will be appreciated that the above-disclosed features and functions, or alternatives thereof, may be desirably combined into different methods and systems. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for inhibiting scale deposition in a geothermal system, the method comprising:
treating a water stream of the geothermal system with a scale inhibitor composition,
wherein the scale inhibitor composition comprises a compound that includes a peptide bond.

2. The method of claim 1, wherein the compound that includes the peptide bond is a polypeptide.

3. The method of claim 1, wherein the compound that includes the peptide bond is represented by Formula (I): 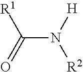
where R¹ and R² are independently a hydrocarbon group optionally substituted by a heteroatom.

4. The method of claim 1, wherein the compound with the peptide bond is polyaspartic acid.

5. The method of claim 1, wherein the compound with the peptide bond has a molecular weight in a range of 50 to 20,000 daltons.

6. The method of claim 1, wherein a dosage of the scale inhibitor composition is in a range of 0.025 to 15 ppm.

7. The method of claim 1, wherein a dosage of the scale inhibitor composition is in a range of 0.1 ppm to 2.5 ppm.

8. The method according to claim 6, wherein the scale inhibitor composition provides at least 10% scale inhibition in the geothermal system at a dosage of 0.1 ppm or less.

9. The method of claim 1, wherein the water stream has an iron concentration in a range of 500 ppm to 2,500 ppm.

10. The method of claim 9, wherein the scale inhibitor composition further comprises a ligand.

11. The method of claim 1, wherein the scale inhibitor composition is thermally stable at a temperature in a range of 20 to 300° C. and at a pressure in a range of 10 to 500 psi.

12. The method of claim 1, wherein the scale inhibitor composition further comprises a ligand.

13. The method of claim 12, wherein the ligand is an organic acid or an aminomethylenecarboxlates.

14. The method according to claim 12, wherein the ligand is at least one selected from the group consisting of citric acid, EDTA, GLDA, and MGDA.

15. The method of claim 1, wherein the scale inhibitor composition further comprises a dispersant polymer.

16. The method of claim 1, wherein the scale inhibitor composition reduces an amount of radiation measured in the geothermal system to less than 3,000 Bq/kg.
